(19) United States
(12) Patent Application Publication
(10) Pub. No.: US 2026/0169731 A1
(43) Pub. Date: Jun. 18, 2026

(54) Monitoring and Managing Cryptographic Libraries in Software Development

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/983,503

(22) Filed: Dec. 17, 2024

(51) Int. Cl. G06F 8/71

(52) U.S. Cl. CPC G06F 8/71

(57) ABSTRACT

Systems and methods for monitoring and managing cryptographic libraries within a version control system include steps of subsequent to integrating a monitoring agent with the version control system as a hook or plugin that triggers upon one or more version control events including commits, pushes, or merges, continuously observing code changes in real-time as source code is committed to the version control system; analyzing newly added or modified files within the committed code to detect cryptographic libraries and associated cryptographic functions; and generating alerts upon detection of introduced, deprecated, or vulnerable cryptographic components.

### FIELD OF THE DISCLOSURE

The present disclosure generally relates to computer and networking systems and methods. More particularly, the present disclosure relates to systems and methods for monitoring and managing cryptographic libraries in software development.

### BACKGROUND OF THE DISCLOSURE

Cryptographic libraries serve as the backbone for secure communication, data protection, and authentication, providing the mathematical operations and protocols necessary to safeguard sensitive information. Given their critical role, organizations must carefully manage and accurately identify these libraries to ensure robust encryption standards, maintain compliance with evolving regulatory requirements, and mitigate security risks. However, discovery tools tasked with locating and cataloging cryptographic libraries face a wide range of challenges in modern, complex computing environments. They often struggle to detect embedded or custom libraries hidden deep within proprietary codebases, where non-standard naming conventions and unique implementations make straightforward identification nearly impossible. Tools that rely primarily on static analysis are particularly limited, as they can easily overlook dynamically loaded libraries and runtime modifications that only become evident during actual operation, leaving a blind spot for real-time cryptographic function usage. Beyond merely locating these libraries, it can be difficult for conventional tools to discern which cryptographic modules are actively utilized in critical processes versus those that are outdated or dormant, further complicating inventory accuracy.

As cryptographic standards evolve and new algorithms emerge—while older ones are deprecated—detection tools are frequently slow to adapt, potentially missing recently introduced methods or failing to flag libraries that no longer meet compliance requirements. This sluggish response impedes organizations from maintaining a current, secure cryptographic posture, makes adherence to regulatory standards more complicated, and ultimately hinders effective risk management. In addition, the sheer diversity of platforms, programming languages, and frameworks that organizations rely on can introduce inconsistencies in how cryptographic libraries are integrated and maintained, exacerbating the difficulty of achieving complete visibility. Taken together, these issues highlight the inherent complexity and risk associated with relying on conventional approaches to managing cryptographic libraries.

### BRIEF SUMMARY OF THE DISCLOSURE

The present disclosure relates to systems and methods for monitoring and managing cryptographic libraries in software development. A proactive solution for managing cryptographic libraries involves an observation-based approach that integrates a monitoring agent directly within the development lifecycle—such as through GitHub or other version control systems—so it continuously observes code changes as they are committed, modified, or merged, and flags cryptographic library updates, additions, or deletions in real-time. By immediately alerting developers to deprecated or insecure cryptographic functions and tracking the introduction of new libraries, this “pocket-sized” agent helps prevent issues from reaching production and enables an up-to-date, dynamic inventory of cryptographic assets. Unlike traditional discovery tools, this method provides real-time compliance and security insights, ensuring continuous, observation-based tracking that supports robust cryptographic risk management throughout the entire software lifecycle.

### BRIEF DESCRIPTION OF THE DRAWINGS

The present disclosure is detailed through various drawings, where like components or steps are indicated by identical reference numbers for clarity and consistency.

FIG. 1 illustrates a diagram of a system for monitoring and managing cryptographic libraries in software development.

FIG. 2 illustrates a block diagram of a computing system which can serve as a foundation for various elements involved in secure software development workflows.

FIG. 3 illustrates a flowchart of a process for monitoring and managing cryptographic libraries within a version control system.

### DETAILED DESCRIPTION OF THE DISCLOSURE

Again, the present disclosure relates to systems and methods for monitoring and managing cryptographic libraries in software development.

### Cryptographic Libraries

“Cryptographic libraries” refer to structured sets of code—spanning modules, functions, classes, or entire packages—designed to handle cryptographic operations such as encryption, decryption, hashing, digital signatures, key management, and related security protocols. These libraries function as the foundational building blocks that enable software applications to protect sensitive data, ensure secure communication channels, and authenticate users or systems. Because cryptographic standards and best practices continually evolve—and because vulnerabilities in these libraries can compromise entire security architectures—organizations must have clear visibility into where and how these components are incorporated.

Identifying these libraries, however, can be complex and non-trivial. They may be integrated in multiple ways:
(1) Within the Application's Source Code: Some cryptographic libraries are implemented as custom code directly merged into the application's logic. Developers might integrate cryptographic routines at a granular level, making the libraries difficult to distinguish from standard business logic. In these scenarios, functions for encryption or signature verification may not be neatly separated, but interwoven with proprietary code, using non-standard naming conventions or data structures. This integration can obscure their presence, causing traditional scanning tools, which often rely on known signatures or patterns, to miss such embedded libraries entirely.
(2) Linked as External Dependencies: Many applications rely on standard, well-known cryptographic libraries such as OpenSSL, Bouncy Castle, or Microsoft's Cryptographic application programming interface (API) (CAPI). These libraries are often pulled in during the build process or managed via package managers. While this method can streamline maintenance and updates, it also introduces complexity: a library might be linked in multiple ways across different modules or services. Some libraries are versioned differently in various parts of the codebase, and others may remain present but unused. Over time, maintaining an accurate inventory of which versions are in active use—and ensuring that deprecated libraries are removed—becomes challenging.
(3) Dynamically Loaded at Runtime: In some architectures, cryptographic libraries are not statically linked into the application but instead loaded dynamically as the program runs. This approach might involve on-demand fetching from remote servers, plugin architectures that inject cryptographic modules at runtime, or the selective loading of libraries based on environmental conditions. For instance, a system might load a particular encryption module only if it detects specific regulatory requirements in the deployment region. Such dynamic behavior makes static analysis less effective, as the code necessary to identify the library's presence may only be evident during execution. Tools must therefore adopt runtime analysis or instrumentation techniques to capture these ephemeral integrations.
(4) Obfuscated or Embedded in Complex Environments: In complex, proprietary, or highly integrated systems, cryptographic code can be deeply buried. Libraries may be compiled into larger binary blobs, stripped of identifiable signatures, or packed alongside other functionalities in containerized environments or virtual machines. They might also appear in code “shards” distributed across multiple microservices, each handling a piece of the cryptographic logic. In highly specialized or regulated industries, engineers might rely on hardware-backed cryptography (e.g., secure enclaves or trusted platform modules), further complicating identification. Such obfuscation or fragmentation makes conventional scanning techniques—often reliant on known patterns or file structures—ineffective.

Due to these varied locations and integration patterns, traditional discovery approaches frequently produce incomplete or inaccurate results. They might fail to detect custom libraries thoroughly embedded in source code, overlook dynamically loaded modules that never appear during static scans, or conflate outdated libraries lurking in the codebase with those actively safeguarding critical processes. As a result, organizations risk maintaining a flawed understanding of their cryptographic landscape, complicating ongoing compliance efforts, leaving security gaps unaddressed, and hindering proactive risk management strategies.

### System for Monitoring and Managing Cryptographic Libraries in Software Development

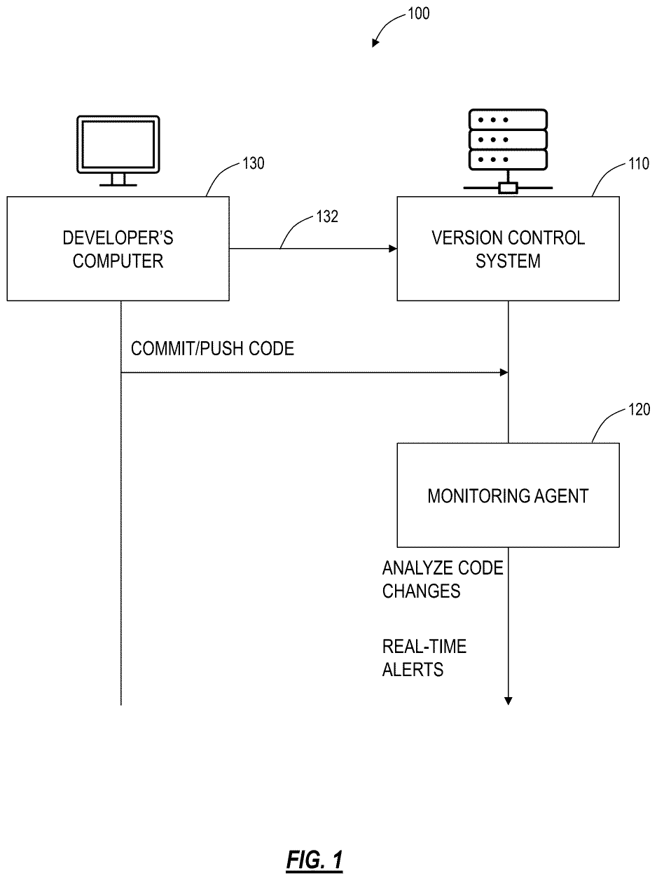

FIG. 1 illustrates a diagram of a system 100 for monitoring and managing cryptographic libraries in software development. For illustration purposes, the system 100 depicts three primary components—a version control system (VCS) 110, a monitoring agent 120, and a developer's computer 130—and the information flow between them, highlighting how an observation-based approach can track cryptographic library usage in real-time.

The developer's computer 130 represents the coding environment where engineers actively write and modify application code. As changes are made—such as adding new cryptographic libraries, updating existing encryption methods, or removing outdated cryptographic code—these modifications are prepared for version control via commits and eventually pushed upstream. The arrow 132 from the developer's computer 130 to the version control system 110 indicates the transfer of code changes from the local development workstation into a central repository.

The version control system 110 (e.g., GitHub) stores the project's source code history and facilitates collaborative development. When developers push their commits, the version control system 110 updates its stored record of code versions, branches, and merges. The version control system 110 may be physically implemented and hosted on-premises, on a local server within an organization's infrastructure, as a cloud-based service managed by third-party providers, or the like. The version control system 110 is a repository that manages changes to source code, documentation, and other development artifacts over time. By tracking every modification committed to the repository, it provides a structured historical record that developers can reference to understand the evolution of a project. With features like branching and merging, the version control system 110 enables parallel development, allowing multiple team members to work concurrently on various components without overwriting each other's code. It also supports easy rollback to previous states, facilitating the rapid identification and reversal of problematic changes. Integrations with continuous integration (CI) pipelines, issue trackers, and monitoring agents further extend a version control system's 110 capabilities, enabling automated testing, code review workflows, and real-time inspection of cryptographic libraries or other security-related elements. In essence, the version control system 110 serves as the collaborative, traceable backbone of modern software development, ensuring code integrity, auditability, and maintainability.

The monitoring agent 120 can be integrated directly into the version control system 110 by configuring it as a hook or plugin that triggers upon commit, push, or merge events, ensuring seamless integration into the existing development workflow. Integrated in this manner, the agent 120 is not merely a passive scanner; rather, it continuously “observes” code changes as they progress through the commit and push process. Instead of performing periodic scans after code has settled into the repository, the agent 120 intercepts and inspects each commit in real-time. By doing so, the agent 120 analyzes newly added or modified files, looking specifically for cryptographic libraries and their associated functions, ranging from symmetric and asymmetric encryption routines to hashing algorithms, digital signature mechanisms, and key management utilities. Examining these changes in-flight enables the agent to detect the introduction of new cryptographic functions, identify deprecated libraries that persist in the codebase, and flag suspicious or non-compliant cryptographic techniques that might compromise security or compliance efforts.

When the monitoring agent 120 flags a change—such as an insecure encryption algorithm, a known-vulnerable cryptographic library version, or a newly added cryptographic module that requires review—it provides alerts, such as back to the developer's computer 130. This feedback loop ensures developers are notified immediately rather than discovering issues later in the software lifecycle. As a result, engineers can quickly address problematic code, remove outdated libraries, or replace vulnerable implementations with more secure alternatives before these issues propagate to production.

The system 100 encapsulates an ecosystem where code originates on the developer's computer 130, travels through the version control system 110, and undergoes continuous scrutiny by the monitoring agent 120. This real-time, observation-based strategy maintains a dynamic, accurate inventory of cryptographic components, thereby enabling rapid response to compliance changes, enhancing security posture, and streamlining risk management practices.

### Detection of Cryptographic Libraries

There are several ways in which the monitoring agent 120 integrated with the version control system 110 can detect cryptographic libraries, each leveraging distinct technical approaches. By combining these techniques, the agent 120 can achieve high accuracy and comprehensive coverage:
(1) Signature-Based Detection (Static Pattern Matching): One straightforward method involves scanning code as it is committed for known signatures or identifiers associated with popular cryptographic libraries. For example, if the developer imports a well-known library—such as import javax.crypto.Cipher in Java, use OpenSSL::Cipher in Ruby, or #include <openssl/evp.h> in C—the monitoring agent 120 can immediately flag the presence of recognized cryptographic functions. This approach often relies on a curated database of known library entry points, class names, filenames, or specific function calls (e.g., AES_encrypt, RSA_sign). When a match is found, the agent 120 logs the detection event, enabling further analysis or immediate alerting.
(2) Dependency and Build Manifest Analysis: Many projects define their dependencies in files such as requirements.txt (Python), package.json (Node.js), pom.xml (Maven), or Cargo.toml (Rust). The monitoring agent 120 can parse these manifests at commit-time to identify cryptographic libraries, either explicitly declared or transitively included as a sub-dependency. By comparing these entries against a database of known cryptographic packages and their versions, the agent 120 can detect when new crypto libraries enter the codebase, when older versions remain present, or when certain libraries are updated in ways that might require compliance checks.
(3) Code Instrumentation and Hooks into CI/CD Pipelines (Static+Dynamic Analysis): In cases where libraries are not clearly referenced or may be obfuscated, the monitoring agent 120 could integrate with continuous integration (CI) pipelines to run lightweight static analyzers or code linters. These tools can perform more advanced pattern recognition, such as detecting cryptographic primitives (e.g., identifying patterns associated with key derivation functions or block cipher modes of operation) even if the library is not explicitly named. In some advanced scenarios, the agent 120 could trigger a minimal test execution phase or a “dry run” of compilation steps to reveal dynamically included headers, dynamically fetched modules, or compile-time generated cryptographic code segments. While not a full dynamic runtime analysis, this semi-dynamic approach can still surface cryptographic routines that aren't directly visible in static imports.
(4) Metadata and Annotation Analysis: Developers sometimes annotate their code with metadata or comments to describe certain modules or compliance-related information. The monitoring agent 120 can search for comments or annotations like @crypto, #FIPS 140-2, or similar markers developers insert intentionally for documentation. Such metadata can be especially helpful in proprietary codebases where cryptographic libraries are not recognizable through standard signatures. By establishing a naming or tagging convention internally, organizations can help the agent 120 identify cryptographic code segments that might otherwise be missed.
(5) Binary and Bytecode Inspection (When Source Code Is not Clear): For languages that compile down to bytecode or binary files (e.g., Java class files or Go binaries), the monitoring agent 120 can perform a limited form of binary inspection at commit-time. This involves scanning the compiled artifacts for recognizable bytecode patterns, symbol names, or known cryptographic library identifiers embedded in the binary. Although more computationally expensive, this method can detect cryptographic libraries that are dynamically included during build steps or are hidden behind build-time obfuscation. If the build process is integrated into the commit workflow (e.g., pre-commit hooks or a post-commit CI job), the agent 120 can capture these indicators without requiring the application to run fully in a production-like environment.
(6) Cross-Referencing Known Vulnerability Databases and Security Feeds: The monitoring agent 120 could regularly consult external feeds such as the NVD (National Vulnerability Database) or community-maintained lists to identify which file paths, function signatures, or package names are associated with known cryptographic libraries and their known vulnerabilities. When the agent 120 detects code resembling entries from these databases, it flags the occurrence and possibly correlates it with known security issues. For example, if the agent 120 finds a match against a cryptographic library version known to have a critical flaw, it can raise an immediate high-priority alert.
(7) Heuristic and Machine Learning-Based Detection: As a more advanced technique, the monitoring agent could employ machine learning models trained on large datasets of open-source code to identify cryptographic patterns. This might involve recognizing common API usage patterns, data structures frequently associated with key storage, or particular code flow characteristics of cryptographic routines. Over time, these heuristics can improve, allowing the agent 120 to detect cryptographic code even if it's written in a non-standard way or partially obfuscated.

By applying a combination of these techniques—ranging from simple signature-based rules to more sophisticated heuristic or machine learning approaches—the monitoring agent 120 can achieve a robust, real-time understanding of cryptographic libraries introduced, modified, or removed at each commit. This multilayered detection capability ensures that security and compliance teams maintain an accurate and up-to-date inventory of cryptographic assets throughout the development lifecycle.

### Benefits of Real-Time Monitoring

Real-time detection using the monitoring agent 120 offers several key advantages over traditional library scanning approaches that rely on periodic, post-commit analysis:
(1) Immediate Feedback: Conventional scanning tools typically review code at predetermined intervals, such as nightly builds or scheduled security checks. By contrast, the monitoring agent 120 integrated into the version control system 110 can intercept code changes as soon as they are committed, providing developers with immediate alerts. This real-time feedback loop empowers developers to address issues—such as the introduction of an outdated cryptographic library or a known-vulnerable encryption function—before the problematic code propagates into subsequent stages of the development pipeline.
(2) Enhanced Accuracy Through Contextual Awareness: Static or periodic scans often operate on stale snapshots of a codebase, potentially missing dependencies that are dynamically introduced or removed between scans. The monitoring agent 120 continuously “observes” code commits as they happen, enabling it to detect cryptographic libraries in their actual, current state. This in-the-moment assessment reduces the likelihood of overlooking newly introduced libraries, runtime modifications, or conditional code paths that would otherwise remain hidden from traditional tools.
(3) Reduced Technical Debt and Faster Remediation: Delayed discovery of problematic libraries leads to technical debt, as developers may have to revisit and refactor code long after it was written. With real-time detection, developers can address cryptographic issues at the moment they appear, preventing outdated libraries or insecure functions from becoming entrenched within the codebase. Early detection reduces the effort required for remediation and helps maintain a cleaner, more compliant code environment.
(4) Continuous Compliance and Security Posture: As cryptographic standards evolve—whether through the introduction of new algorithms or the deprecation of older ones—maintaining continuous compliance becomes challenging. Traditional scanning methods struggle to keep pace and may only identify compliance gaps after code has already been integrated. The monitoring agent 120, working in tandem with up-to-date policies and vulnerability databases, ensures that the code is consistently evaluated against current security standards, helping organizations maintain an ongoing, proactive security posture rather than reacting after the fact.
(5) Seamless Integration and Scalability: Real-time monitoring agents can be seamlessly integrated as hooks or plugins within the version control system. This tight coupling allows the agent 120 to scale naturally with development team size and code complexity. Instead of performing heavy batch scans that may strain resources, the monitoring agent 120 distributes its workload across individual commit events, improving overall efficiency and ensuring the solution remains effective as projects grow larger and more complex.

In essence, adopting a real-time monitoring agent for cryptographic library detection streamlines the security review process, ensures immediate and contextually relevant feedback for developers, and helps organizations maintain continuous compliance and risk management, all while reducing technical debt and improving overall code quality.

### Example Computing System Architecture

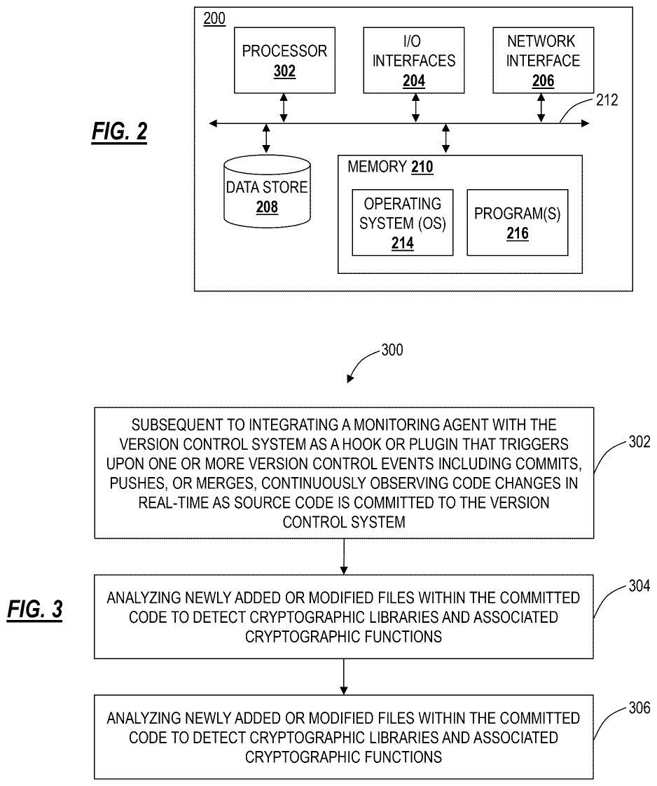

FIG. 2 illustrates a block diagram of a computing system 200 which can serve as a foundation for various elements involved in secure software development workflows. Conceptually, the computing system 200 can be implemented using various forms of underlying infrastructure, including physical servers, clusters of machines, virtual machines (VMs) running on hypervisors, or serverless computing frameworks. Regardless of its deployment model, the computing system 200 generally includes a processor 202, input/output (I/O) interfaces 204, a network interface 206, a data store 208, and memory 210. The computing system 200 can host or interface with the version control system 110, the monitoring agent 120, and the developer's computer 130, thereby enabling an integrated environment for managing cryptographic libraries.

The version control system 110 is a specialized service or application that may be deployed on one or more computing systems 200, providing a central repository for source code, documentation, and other development artifacts. In practice, the version control system 110 can be hosted on-premises or accessed through a cloud-based service, relying on the underlying computing system's scalability, storage, and network capabilities to manage branching, merging, and tracking changes over time. The version control system 110 operates above the O/S 214 layer, leveraging the memory 210 and data store 208 for maintaining a structured historical record of code modifications. Integrations with the monitoring agent 120 and the developer's computer 130 are facilitated by the network interface 206, allowing seamless collaboration and real-time updates.

The monitoring agent 120 is a software component or set of services that may be installed as a plugin, hook, or background process within the computing system 200 running the version control system 110 or operating in close proximity to it. Integrated via the version control system 110 workflows, the monitoring agent 120 continuously observes code changes, analyzing newly committed files to detect cryptographic libraries, deprecated encryption methods, or insecure implementations. It utilizes the processor 202 for executing advanced detection algorithms, the memory 210 for in-flight analysis, and the data store 208 for reference data such as cryptographic function signatures or vulnerability databases. By relying on I/O interfaces 204, the monitoring agent 120 can interact with external tools or logs, and through the network interface 206, it can send alerts back to the developer's computer 130.

The developer's computer 130 represents the coding environment where engineers author, modify, and test software. It may be a separate computing system 200 —such as a developer's laptop, workstation, or virtual desktop—or a client machine connecting remotely to the version control system 110 and the monitoring agent 120. The developer's computer 130 can push changes over a secure network connection managed by the network interface 206, triggering the monitoring agent's 120 inspection process. In turn, any alerts or findings are communicated back, enabling real-time feedback loops that inform developers about the security and compliance state of their changes before they propagate to production systems.

It should be noted that FIG. 2 is a simplified representation of the computing system 200 and that practical implementations may employ additional hardware and software elements (e.g., accelerators, GPUs, FPGAs, dedicated cryptographic modules, caching layers, etc.) as well as more complex interconnect fabrics for high throughput and low latency. The illustrated components (202, 204, 206, 208, and 210) are coupled via a local interface 212, which may include one or more wired or wireless buses, high-speed interconnects, or sophisticated switching fabrics. In addition, the local interface 212 may incorporate a variety of controllers, buffers, caches, drivers, repeaters, and receivers, along with addressing and control lines, to facilitate efficient communication and resource sharing among components.

The processor 202 is a hardware device—such as a central processing unit (CPU), multicore processor, system on chip (SoC), or part of a larger compute cluster—designed to execute instructions. The processor 202 may be a general-purpose processor, a specialized processor, or a combination thereof. When the computing system 200 operates, the processor 202 retrieves and executes instructions stored in memory 210, orchestrating data exchanges with the data store 208 and managing the system's overall operations, including those performed by the version control system 110 and the monitoring agent 120. In larger deployments, multiple processors can work in parallel to handle high traffic volumes, complex detection routines, and large codebases.

The I/O interfaces 204 enable external interaction with peripherals, while the network interface 206 provides secure connectivity to external networks, including the Internet, corporate LANs, or cloud platforms. Secure transports and encryption ensure that sensitive data, code, and cryptographic library information remain protected in transit. The data store 208 maintains persistent or temporary storage for application binaries, system logs, cryptographic signatures, or reference datasets, while the memory 210 serves as the primary working memory for executing software instructions, including those of the operating system (O/S) 214 and the programs 216 that implement the functionalities described herein—such as the version control system 110 logic, monitoring agent 120 algorithms, and any related services.

In summary, the computing system 200 provides a foundational building block for implementing a secure, integrated environment where a developer's computer can communicate with the version control system 110 and a monitoring agent 120. Its modular, scalable hardware and software components enable robust and flexible implementations, ensuring reliable operation, efficient execution, and secure management of cryptographic libraries throughout the software development lifecycle.

### Process

FIG. 3 illustrates a flowchart of a process 300 for monitoring and managing cryptographic libraries within a version control system. The process 300 may be implemented as a series of method steps executed by the computing system 200, or a similar platform configured to perform these steps. Additionally, the process 300 may be embodied on a non-transitory computer-readable medium storing instructions that, when executed by one or more processors, cause the computing system to carry out the described steps.

The process 300 includes subsequent to integrating a monitoring agent with the version control system as a hook or plugin that triggers upon one or more version control events including commits, pushes, or merges, continuously observing code changes in real-time as source code is committed to the version control system (step 302); analyzing newly added or modified files within the committed code to detect cryptographic libraries and associated cryptographic functions (step 304); and generating alerts upon detection of introduced, deprecated, or vulnerable cryptographic components (step 306).

The process 300 can also include comparing identified cryptographic libraries and their versions against a database of known secure and vulnerable libraries, and flagging libraries known to present security or compliance risks. The analyzing newly added or modified files can include performing static pattern matching to identify recognized cryptographic libraries through known signatures, class names, file names, or function calls. The analyzing newly added or modified files can include parsing dependency and build manifest files to identify cryptographic libraries introduced as external dependencies or sub-dependencies. The monitoring agent integrates with a continuous integration (CI) pipeline to perform static or semi-dynamic analysis, including triggering lightweight test executions of compilation steps to detect dynamically included cryptographic libraries.

The process 300 can also include inspecting developer-supplied metadata, comments, or annotations in the source code that explicitly indicate cryptographic functionality or compliance-related information. The analyzing cryptographic libraries can further include inspecting compiled artifacts including bytecode or binaries to identify cryptographic routines that are not evident in the source code. The process 300 can further include cross-referencing detected cryptographic libraries against external vulnerability databases or security feeds, and issuing alerts when libraries with known critical flaws are detected. The process 300 can further include employing heuristic or machine learning-based detection models trained to recognize cryptographic usage patterns, key-related data structures, or indicative code flows associated with cryptographic operations. The alerts generated by the monitoring agent can be transmitted to developer environments, issue trackers, or security dashboards to provide immediate notification and facilitate prompt remediation before potentially insecure code is deployed.

### Remediation

Once alerts are generated by the monitoring agent 120, developers and security teams can take a variety of remediation approaches to address the underlying issues before they propagate into production environments. These approaches may include:
(1) Library Upgrades and Replacements: If the alert identifies a deprecated or known-vulnerable cryptographic library, a straightforward remediation involves replacing it with a newer, more secure version. Developers can consult official documentation, security advisories, or community recommendations to select upgraded libraries that are actively maintained and comply with the latest security standards and best practices.
(2) Refactoring Code to Use Approved Functions: In cases where a deprecated or insecure cryptographic function is flagged, developers can refactor the code to rely on approved cryptographic routines. This may entail migrating from outdated encryption methods (e.g., RC4, MD5) to more secure ones (e.g., AES-256, SHA-256) and ensuring that any key management, padding, or mode-of-operation details align with established security guidelines.
(3) Implementing Policy-Driven Constraints: Organizations can enforce policies that restrict the use of certain cryptographic libraries, functions, or parameters. Based on alerts, these policies can be refined to block commits that introduce known-vulnerable libraries or mandate the use of FIPS-compliant modules. In practice, this might mean adding automated checks to the CI pipeline or integrating with the version control system's pre-commit hooks so that developers cannot merge non-compliant code without approval.
(4) Integrating Additional Tooling or Testing: If alerts reveal a pattern of misusing cryptographic libraries, teams may integrate additional static analysis tools, security scanners, or specialized cryptographic linters into the pipeline. Over time, these tools help maintain code quality and enforce secure coding practices, reducing the frequency and severity of future alerts.
(5) Developer Education and Training: Alerts present an opportunity for ongoing improvement. Security teams can use them as teaching moments, providing developers with guidance on secure coding techniques, updated cryptographic standards, and best practices for library selection. This may include conducting workshops, distributing internal wikis or knowledge bases, and offering secure coding certifications. Improved developer awareness can reduce repeat occurrences of similar issues.
(6) Re-Validating Compliance and Updating Documentation: When alerts arise due to compliance-related shortfalls (e.g., failing to meet a regulatory requirement or corporate policy), remediation may involve reviewing and updating internal documentation, security policies, and code review checklists. Regular audits, informed by recurring alerts, can ensure that compliance remains a living aspect of the development lifecycle rather than a one-time check.
(7) Engaging Security or Cryptography Experts: For complex issues—such as cryptographic design flaws, uncertain algorithm selection, or intricate key management practices—teams may benefit from consulting with in-house or third-party cryptography experts. External guidance can help confirm that chosen libraries and algorithms meet the required security properties and suggest architecture-level changes for long-term improvements.

By combining these remediation approaches, organizations can address immediate issues revealed by alerts, reinforce secure coding behaviors, and strengthen their overall cryptographic posture.

### Benefits

This approach delivers significant benefits over conventional solutions by providing immediate, context-aware insights into cryptographic library usage as code is committed, rather than relying on delayed, periodic scans. With real-time detection integrated directly into the version control system, developers receive instant feedback on introduced, outdated, or insecure cryptographic functions and libraries. This prevents issues from lingering undetected and escalating into production, reducing the burden of retroactive fixes, mitigating security and compliance risks earlier, and minimizing technical debt. Additionally, continuous observation enables a more accurate, dynamic view of the codebase's cryptographic landscape, ensuring compliance with evolving standards and rapidly surfacing new vulnerabilities. Together, these advantages streamline remediation, enhance development workflows, improve maintainability, and result in a more proactive, robust security posture than traditional, after-the-fact scanning methods.

### Processing Circuitry and Non-transitory Computer-readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method of monitoring and managing cryptographic libraries within a version control system, the method comprising steps of:
subsequent to integrating a monitoring agent with the version control system as a hook or plugin that triggers upon one or more version control events including commits, pushes, or merges, continuously observing code changes in real-time as source code is committed to the version control system;
analyzing newly added or modified files within the committed code to detect cryptographic libraries and associated cryptographic functions; and
generating alerts upon detection of introduced, deprecated, or vulnerable cryptographic components.

2. The method of claim 1, where the steps further include comparing identified cryptographic libraries and their versions against a database of known secure and vulnerable libraries, and flagging libraries known to present security or compliance risks.

3. The method of claim 1, wherein the analyzing newly added or modified files comprises performing static pattern matching to identify recognized cryptographic libraries through known signatures, class names, file names, or function calls.

4. The method of claim 1, wherein the analyzing newly added or modified files includes parsing dependency and build manifest files to identify cryptographic libraries introduced as external dependencies or sub-dependencies.

5. The method of claim 1, wherein the monitoring agent integrates with a continuous integration (CI) pipeline to perform static or semi-dynamic analysis, including triggering lightweight test executions of compilation steps to detect dynamically included cryptographic libraries.

6. The method of claim 1, wherein the steps further include inspecting developer-supplied metadata, comments, or annotations in the source code that explicitly indicate cryptographic functionality or compliance-related information.

7. The method of claim 1, wherein the analyzing newly added or modified files further includes inspecting compiled artifacts including bytecode or binaries to identify cryptographic routines that are not evident in the source code.

8. The method of claim 1, wherein the steps further include cross-referencing detected cryptographic libraries against external vulnerability databases or security feeds, and issuing alerts when libraries with known critical flaws are detected.

9. The method of claim 1, wherein the steps further include employing heuristic or machine learning-based detection models trained to recognize cryptographic usage patterns, key-related data structures, or indicative code flows associated with cryptographic operations.

10. The method of claim 1, wherein the alerts generated by the monitoring agent are transmitted to developer environments, issue trackers, or security dashboards to provide immediate notification and facilitate prompt remediation before potentially insecure code is deployed.

11. A system for monitoring and managing cryptographic libraries within a version control system, the system comprising:
one or more processors and memory storing instructions that, when executed, cause the one or more processors to
subsequent to integrating a monitoring agent with the version control system as a hook or plugin that triggers upon one or more version control events including commits, pushes, or merges, continuously observe code changes in real-time as source code is committed to the version control system;
analyze newly added or modified files within the committed code to detect cryptographic libraries and associated cryptographic functions; and
generate alerts upon detection of introduced, deprecated, or vulnerable cryptographic components.

12. The system of claim 11, where the instructions that, when executed, further cause the one or more processors to
compare identified cryptographic libraries and their versions against a database of known secure and vulnerable libraries, and flagging libraries known to present security or compliance risks.

13. The system of claim 11, wherein the newly added or modified files are analyzed by performing static pattern matching to identify recognized cryptographic libraries through known signatures, class names, file names, or function calls.

14. The system of claim 11, wherein the newly added or modified files are analyzed by parsing dependency and build manifest files to identify cryptographic libraries introduced as external dependencies or sub-dependencies.

15. The system of claim 11, wherein the monitoring agent integrates with a continuous integration (CI) pipeline to perform static or semi-dynamic analysis, including triggering lightweight test executions of compilation steps to detect dynamically included cryptographic libraries.

16. The system of claim 11, where the instructions that, when executed, further cause the one or more processors to
inspect developer-supplied metadata, comments, or annotations in the source code that explicitly indicate cryptographic functionality or compliance-related information.

17. The system of claim 11, wherein the newly added or modified files includes inspecting compiled artifacts including bytecode or binaries to identify cryptographic routines that are not evident in the source code.

18. The system of claim 11, where the instructions that, when executed, further cause the one or more processors to
cross-reference detected cryptographic libraries against external vulnerability databases or security feeds, and issuing alerts when libraries with known critical flaws are detected.

19. The system of claim 11, where the instructions that, when executed, further cause the one or more processors to
employ heuristic or machine learning-based detection models trained to recognize cryptographic usage patterns, key-related data structures, or indicative code flows associated with cryptographic operations.

20. The system of claim 11, wherein the alerts generated by the monitoring agent are transmitted to developer environments, issue trackers, or security dashboards to provide immediate notification and facilitate prompt remediation before potentially insecure code is deployed.
